(19) United States
(12) Patent Application Publication
(10) Pub. No.: US 2012/0266637 A1
(43) Pub. Date: Oct. 25, 2012

(54) ANTITHEFT DEVICE FOR THE STEERING COLUMN OF A VEHICLE PROVIDED WITH A BACKLASH BOLT ACTUATOR

(75) Inventor: Guillaume Lesueur, Creteil Cedex (FR)

(73) Assignee: VALEO SECURITE HABITACLE, Créteil Cedex (FR)

(21) Appl. No.: 13/497,265

(22) PCT Filed: Oct. 20, 2010
(86) PCT No.: PCT/EP2010/065818

§ 371 Date: Jul. 12, 2012

(30) Foreign Application Priority Data
Nov. 5, 2009 (FR) 0905313

(51) Int. Cl. B60R 25/02

(52) U.S. Cl. 70/187

(57) ABSTRACT

The invention relates to an antitheft device for the steering column of a vehicle, including: a bolt (8) capable of assuming a position for blocking a steering column; and an actuator (18) for maneuvering the bolt. The device is arranged such that a movement of the actuator (18), in order to remove the bolt (8) from the locking position, from a position in which the bolt is placed in a locking position, begins with a backlash that does not result in any movement of the bolt.

The invention relates to antitheft devices for vehicle steering columns.

These devices generally comprise the lock for the ignition key of the vehicle and a bolt capable of blocking unauthorized movement of the column, in particular when the ignition key is not in the lock. They are also often provided with a so-called deadlock function, the purpose of which is to keep the column blocked even if a criminal has broken the part of the device carrying the lock. The bolt is then immobilized in a position in which it blocks the steering column from being maneuvered.

However, when the front part of the device carrying the lock breaks, its displacement can cause a pull rod used to maneuver the bolt to be displaced, and consequently also cause the bolt to be displaced. In these conditions, when the deadlock function is triggered, it immobilizes the bolt in a position in which it does not block the steering column from being maneuvered.

One object of the invention is to ensure that the deadlock is also effective in such a case.

To this end, an antitheft device for a vehicle steering column is provided according to the invention, which comprises:
a bolt which can occupy a position in which it blocks a steering column; and
an actuator for maneuvering the bolt,
   the device being designed in such a way that a displacement of the actuator, such that the bolt leaves the blocking position, from a position in which it placed the bolt in the blocking position, begins with dead travel that does not cause the bolt to be displaced.

Thus, when the actuator begins to be displaced, the bolt remains stationary. In these conditions, the deadlock is allowed to occur before the bolt has itself begun to move. The steering column therefore remains effectively blocked by the bolt.

The device is advantageously designed in such a way that any displacement of the actuator with a view to placing the bolt in a blocking position is made without dead travel.

The blocking position is thus always achieved in an appropriate manner.

The device is preferably designed in such a way that, for the same speed of displacement of the actuator, the bolt is displaced by means of the actuator at a greater speed away from the blocking position than toward this position.

Thus, given that the starting and finishing points for the travel of the bolt are identical for both directions and that its displacement away from the blocking position begins after the dead travel of the actuator, the bolt is able to compensate for its lag behind the actuator by means of a faster speed of displacement.

The device is advantageously designed in such a way that the actuator interacts directly with the bolt in order to displace it.

It thus remains simple to make the link between the two members and economical in terms of the number of parts and assembly operations.

The device according to the invention can also have at least any one of the following features:
the device is designed in such a way that the actuator intracts with the bolt with a ramp effect;
the bolt has at least one ramp;
the device has at least one ramp for maneuvering the bolt toward the blocking position and/or away from the blocking position;
the device has two ramps inclined relative to each other in order to maneuver the bolt;
the device has a follower and two ramps associated with the displacement of the bolt toward the blocking position and away from it, respectively, the device being designed in such a way that the follower comes into contact with the two ramps; and
the actuator extends into a cavity of the bolt.

A vehicle which includes a device according to the invention is also provided according to the invention.

Other features and advantages of the invention will become more apparent from the following description of an embodiment given by way of non-limiting example with reference to the attached drawings, in which:

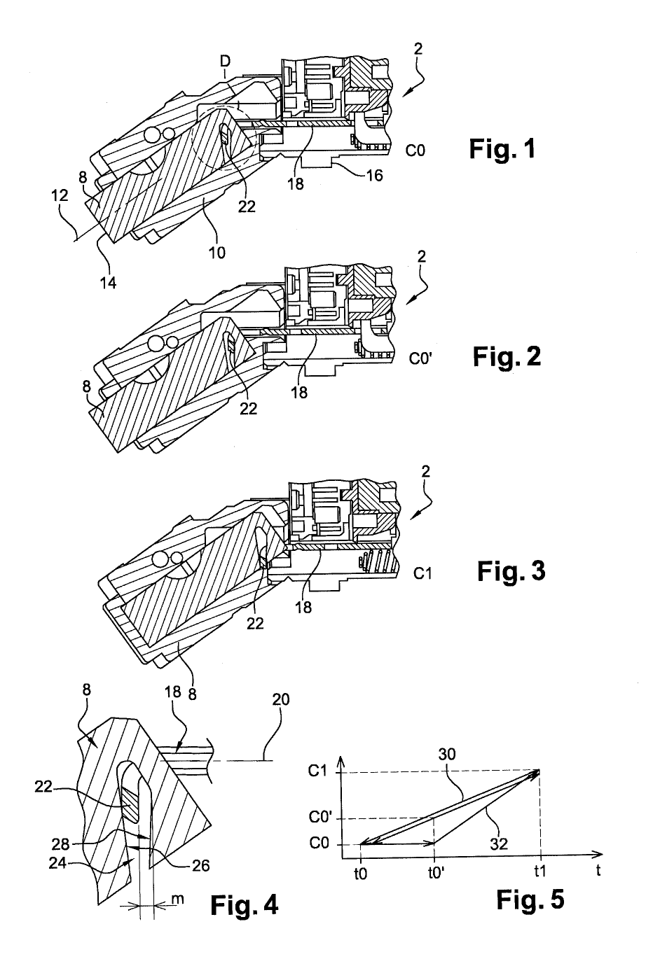

FIGS. 1 to 3 show three views in cross section of a device according to the invention showing three positions of the parts during the displacement of the bolt from the position in which it blocks the steering column;

FIG. 4 is a view on a larger scale of the detail D in FIG. 1; and

FIG. 5 shows curves of the displacement of the parts as a function of time.

An embodiment of the antitheft device 2 according to the invention for a motor vehicle steering column is illustrated in FIGS. 1 to 4. This device comprises in particular a lock operated by a key or a similar member, which has not been illustrated. When the driver of the vehicle puts the key in the lock, a rotor of said lock is rotated in order to turn on the vehicle's electrical system and allow the vehicle to function.

The device comprises in particular a bolt 8 having the general shape of a right parallelepiped and mounted movably so that it can slide in a bolt guide 10. The sliding is in a longitudinal direction 12 of the bolt. When it is in its extended position as illustrated in FIG. 1, the bolt comes into engagement with a member of the steering column of the vehicle by means of the distal end 14 of said bolt in order to block the steering column in rotation about its axis of rotation.

Actuation of the lock by means of the key makes it possible to control the position of the bolt and hence block or unblock the steering column. For more details, reference should be made in particular to patent application WO 2008/074726 filed by the Applicant.

The device 2 comprises a casing 16 that encloses in particular an actuator 18 serving to maneuver the bolt 8. The actuator 18 is formed in this case by a pull rod which for most of its length is straight in shape and extends in a direction 20. The pull rod is mounted movably so that it can slide relative to the casing 16 in this direction.

The actuator has a curved distal end 22 engaged in a cavity 24 of a proximal end of the bolt. Within this cavity, the bolt 8 has in this case two surfaces 26 and 28 forming ramps for the end 22 that forms a follower intended to bear against these ramps. Each of the ramps 26 and 28 has in this case a preferably plane shape. The two ramps extend facing and at a distance from each other, and are inclined relative to each other. The cavity has a U-shaped general profile and so the two ramps form the inner faces of the legs of the U, the open end of the cavity pointing downward in this case. The bottom of the cavity has a rounded shape. The follower 22, held captive in the cavity 24, therefore brings the actuator 18 into engagement with the bolt 8. The ramp 26, on the left in FIG. 4, is directed toward the right. It serves for the maneuvering of the bolt by the actuator in order to place it in the blocking position. The ramp 28, situated on the right and pointing toward the left, serves for the maneuvering of the bolt by the actuator so that it leaves the blocking position.

The cavity 24 has a greater width in its central part than in its lower part, at the end where it is open. The central part refers to the part occupied by the follower 22 in the position in FIGS. 1 and 4. Indeed, in this position the width of the cavity and that of the follower, measured in the direction 20, are such that the width of the cavity exceeds the width of the follower by the distance m. The follower is therefore in contact via its left face with the ramp 26 without being in contact via its right face with the ramp 28.

The two ramps approach each other as they near the open lower end of the cavity.

The device functions as follows. It is assumed that the parts are initially in the position in FIG. 1, which illustrates the bolt 8 and the actuator 18 before the beginning of the displacement. The two members are at the end of their travel. The bolt 8 is in the position in which it blocks the maneuvering of the column. The actuator 18 is in the position which it has reached to place the bolt 8 in this blocking position. The follower 22 bears against the upper part of the ramp 26.

The driver puts the ignition key into the lock and turns the key, which causes in particular the unblocking of the steering column. In order to do this, inter alia, the actuator 18 begins to be displaced away from the direction of the bolt, to the right in the Figures. The first phase of this displacement places the actuator in the position illustrated in FIG. 2. During this phase, it travels the distance m. The follower therefore leaves the ramp 26 and comes into contact with the ramp 28. During this movement, the bolt is not maneuvered by the actuator. This first phase of displacement therefore constitutes dead travel of the latter.

There follows a second phase in which the parts shift from the position in FIG. 2 to that in FIG. 3. During this phase, the follower 22 remains bearing against the ramp 28. It is displaced in the direction 20 and forces the bolt 8 to slide in the bolt guide 10 in the direction 14, upward and to the right in the Figures. The follower therefore travels along and down the ramp 28. The bolt thus leaves the blocking position and releases the column. FIG. 3 illustrates the actuator 18 and the bolt 8 when they have reached the end of their travel. At this point, the follower 22 is at the lower open end of the cavity 24.

After the vehicle has been used, so that the device immobilizes the steering column again, the actuator 18 is displaced toward the bolt, toward the left. Because the follower 22 has been in contact with the ramp 26 from the beginning, the triggering of the movement of the actuator immediately begins a movement of the bolt toward its blocking position, with no dead travel or with a small amount of play of approximately 0.5 mm between the follower and the ramp 26. The follower 22 climbs along the ramp 26. This movement continues until the bolt reaches its blocking position as illustrated in FIG. 1.

It can therefore be seen that the starting and finishing points of the bolt 8 and of the actuator 18 are identical in both directions of displacement. In contrast, the relative movements of the parts do not happen in the same way in both directions of displacement and not simultaneously.

In FIG. 5, t0, t0′ and t1 refer to the points in time corresponding to FIGS. 1, 2 and 3, and c0, c0′ and c1 to the configurations of the parts in these three Figures. The straight line 30 illustrates the displacement of the actuator 18, whilst the curve 32 formed by three straight-line segments illustrates the displacement of the bolt. It is assumed here, to understand FIG. 5, that the displacement of the actuator 18 takes place at the same speed to place the bolt in the blocking position as to make it leave it. As can be seen in this Figure, the actuator moves at a constant speed and with no interruption or dead travel in either direction of displacement. By comparison, between the points in time t0 and t0′, the actuator is displaced while the bolt remains stationary. During the following interval, between the points in time t0′ and t1, the two parts are displaced simultaneously.

FIG. 5 shows that the speed of the bolt is greater, between the points in time t0′ and t1, namely to shift from the configuration in FIG. 2 to that in FIG. 3, than its speed in the opposite direction at any moment of its displacement. This is logical given that the bolt remained stationary during the interval t0-t0′ and must therefore compensate for its lag during the following interval.

When a criminal acts on the device, it is possible that the actuator 18 is displaced slightly toward the right, for example, if the right-hand part of the antitheft device has been broken. However, the dead travel of the bolt between the points in time t0 and t0′ makes it possible to keep the bolt stationary during the triggering of the deadlock function. The steering column therefore remains immobilized. The mechanism therefore incorporates, as it were, a means for delaying the movement of the bolt relative to that of the actuator.

To this end, it has proven that dead travel m of between 1.5 mm and 3 mm ensures a particularly high probability of such a deadlock of the bolt, and an even more preferable sub-interval for the travel m is an interval of between 1.8 to 2.2 mm.

It may be observed that the invention can take the form of a modification of the mechanical interaction between the bolt and the actuator without there being any modification to the overall lifting travel of the bolt during normal operation. Similarly, the trajectories of the parts remain the same. Only the displacement of the parts is modified in the direction corresponding to the cancellation of the immobilization.

Many modifications can of course be made to the invention without going beyond its scope.

The shape of the ramps 26 and 28 could be modified. In particular, the right-hand ramp 28 could be given a convex curve, which will modify the change of the speed of the bolt to shift from the configuration in FIG. 2 to that in FIG. 3.

A different type of interaction could be provided between the bolt and the actuator than the combination of a ramp and follower. The two members could interact by means of at least one intermediate part.

1. An antitheft device for a vehicle steering column, comprising:
a bolt which occupies a position in which the bolt blocks a steering column; and
an actuator for maneuvering the bolt,
wherein a displacement of the actuator for making the bolt leave the blocking position from a position in which the actuator placed the bolt in the blocking position, begins with dead travel, causing the bolt to remain stationary when the actuator begins to be displaced, wherein the bolt begins displacement away from the blocking position after the dead travel of the actuator.

2. The device as claimed in claim 1, wherein any displacement of the actuator with a view to placing the bolt in a blocking position is made without dead travel.

3. The device as claimed in claim 1, wherein, for a same speed of displacement of the actuator, the bolt is displaced by means of the actuator at a greater speed away from the blocking position than toward the blocking position.

4. The device as claimed in claim 1, wherein the actuator interacts directly with the bolt in order to displace the bolt.

5. The device as claimed in claim 1, wherein the actuator interacts with the bolt with a ramp effect.

6. The device as claimed in claim 1, wherein the bolt has at least one ramp.

7. The device as claimed in claim 1, further comprising at least one plane ramp for maneuvering the bolt toward the blocking position and/or away from the blocking position.

8. The device as claimed in claim 1, further comprising two plane ramps inclined relative to each other for maneuvering the bolt.

9. The device as claimed in claim 1, wherein the actuator extends into a cavity of the bolt.

10. The device as claimed in claim 1, wherein the dead travel has a value of between 1.5 and 3 mm.

11. The device as claimed in claim 1, wherein the dead travel has a value of between 1.8 and 2.2 mm.
